(19) United States
(12) Patent Application Publication
(10) Pub. No.: US 2007/0077179 A1
(43) Pub. Date: Apr. 5, 2007

(54) Component used in microprocess control

(76) Inventors: Dirk Schmalz, Darmstadt (DE); Heinz Allmann, Modautal (DE); Michael Haberl, Dieburg (DE); Hans Muntermann, Langen (DE); Michael Schmelz, Riedstadt (DE); Frank Schwarz, Frankfurt (DE); Reiner Funck, Munster (DE); Astrid Lohe, Karlsruhe (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/555,357

(22) PCT Filed: Apr. 17, 2004
(86) PCT No.: PCT/EP04/04098

§ 371 Date: Nov. 1, 2005

(30) Foreign Application Priority Data
May 9, 2003 (DE) 103 21 115.2
Sep. 24, 2003 (DE) 103 44 227.8

(51) Int. Cl. B01L 3/00

(52) U.S. Cl. 422/100

(57) ABSTRACT

A microprocess part having at least one microfluid process element (4) and having microfluid channel connections (9) has a thermally insulating housing (1) surrounding the microfluid element (4), where the microfluid channel connections (9) are passed through the housing (1), and connecting elements for connecting individual housings (1) are arranged on the housing (1) in such a way that the microfluid channel connections (9) associated with each can be tightly connected to one another. The microfluid element (4) is arranged between a connection block (3) and a heat transfer block (2), where the temperature of the heat transfer block (2) and of the connection block (3) and thus also of the microfluid element (4) can be regulated. A connecting element for connecting individual housings (1) to one another has a conical screw (21) having a threaded section (22) and a conically tapering section (23). A locking pin (18), which has a hole (19) matched to the conical screw (21) and projects out of the first of the housings (1) to be connected, is introduced into a recess (20), matched to the locking pin (18), of a second housing (1) and fixed by means of the conical screw (21), whose conically tapering section (23) engages with the hole (19) of the locking pin (18).

The invention relates to a microprocess part which has at least one microfluid process element.

In recent years, it has been possible increasingly to miniaturise fluid technology, so that today the controlled use of small amounts of fluid in the microlitre range or below is increasingly being employed for research and production purposes in chemical, pharmaceutical and biological areas. Various microreactor elements have been developed which facilitate, for example, the mixing, separation, temperature control and analysis of extremely small amounts of liquid or gas. Complete microreaction systems allow not only very effective and inexpensive production and analysis of chemical substances, but also facilitate for the first time previously impossible reaction processes which are only possible owing to modified fluid dynamics which become established on use of microfluid structures miniaturised in this way.

The production of a microreaction system is very complex owing to the small dimensions of the individual structures and connections. The microreaction system is complex to handle and can easily be damaged during everyday use in the laboratory. In particular for the needs in research facilities, modular microprocess systems have been developed which consist of individual modules which can be connected to one another and which can each include one or more process steps. Thus, a complex microreaction system can be constructed from the individual modules, which include microfluid elements, such as, for example, pumps, mixers or analysis devices. The individual modules here are significantly less expensive to produce and can be replaced in the case of damage without the entire microreaction system having to be replaced.

The individual parts have fluid and optionally further connections which each have to be connected to one another or to external instrument connections in the construction of a microreaction system composed of a plurality of parts. However, the microreaction modules of this type known to date do not have universally usable and standardised connections for fluid and, for example, electric connections. Even if exclusively standard components from a particular system supplier are used, the complex connection technology means that a long construction time is necessary. For research purposes in particular, however, an experiment set-up which changes frequently, i.e. a changed arrangement of individual parts, is necessary and results in a high time consumption necessary during use.

Furthermore, complex control mechanisms for specifically influencing the temperature of individual or all process steps of a microreaction are necessary in many reaction and analytical processes. Most microprocess systems can be cooled and/or heated under certain prerequisites, for example in a regulated heating bath. Specific control of the temperature of only individual process steps is not possible in this way. It is also conceivable to construct the individual microreaction modules completely separately from one another and in each case with mutually independent temperature control. However, this results in a high space requirement and complex and unreliable connection technology via fluid connecting lines, which are often not thermally monitored. Replacement of individual parts or the modification of an experiment set-up is delayed and made more difficult in this way.

The object of the present invention is accordingly to design a microprocess part in such a way that substantial thermal insulation of the individual parts is ensured and at the same time rapid connection, in particular of the fluid connections of the individual parts, is possible.

This object is achieved in accordance with the invention by a microprocess part having at least one microfluid process element and having microfluid channel connections, where the microprocess part is arranged in a thermally insulating housing, the microfluid channel connections are passed through the housing, and connecting elements for connecting individual housings are arranged on the housing in such a way that the microfluid channel connections associated with each can be tightly connected to one another.

The arrangement of the microprocess part in a thermally insulating housing means that the individual parts of a complex microreaction system constructed from a plurality of parts are thermally decoupled from one another in such a way that specific temperature control of the individual microfluid elements of the microprocess part is possible.

The housing has connections arranged on the outside in such a way that, when two housings are connected to one another, connections associated with each are likewise connected to one another. Whereas simply bringing the connections into contact is sufficient in, for example, the case of electrical connections, fluid connections can and must be tightly connected to one another through the use of suitable connection devices. It has been found that a tight fluid connection can be made via commercially available fluid connections even at a low contact pressure of the housings connected to one another. The mechanical and fluid connection technology can be substantially integrated into the housing, so that it is possible to avoid projecting connecting elements, which would otherwise be subjected to increased mechanical stress in everyday use in the laboratory.

It is preferably provided that the microfluid element is surrounded essentially completely by thermally conducting material. The microfluid element can, for example, be accommodated in a metal block which is arranged in the interior of the insulating housing. The good thermal conductivity of the metal block ensures uniform temperature control of the microfluid element accommodated therein, with thermal insulation of the individual microfluid elements being achieved by the surrounding housing. Such a construction of a thermally controllable microfluid element which is thermally decoupled from other parts by an insulating housing enables significantly more precise temperature control which is independent for individual process steps, as is virtually impossible to achieve with microreaction modules separated from one another merely by individual insulating layers, such as, for example, plastic films.

According to an advantageous embodiment of the inventive idea, it is provided that the thermally conducting material is aluminium or copper and the housing could be made of any other suitable material, such as, for example, ceramic or a plastic which meets the requirements. These materials have sufficiently good thermal properties for most requirements, can be processed simply and are sufficiently resistant for everyday use in the laboratory.

It is advantageously provided that the microfluid element is arranged between a connection block having fluid connections arranged in the connection block and a heat transfer block having devices for temperature control. The microfluid element can be arranged between these two blocks, which are preferably made of aluminium or copper and can be connected to one another in a detachable manner, in such a way that, apart from the respective connections, it is completely surrounded by the material of high thermal conductivity used. All connections and contacts for the microfluid element and the temperature control are integrated into the individual blocks. The microfluid element with all fluid and, for example, electric connections is connected in the surrounding blocks, without the individual connections each having to be made manually, by the placing of the microfluid element, usually a microreaction chip, and the subsequent connection of the connection block to the heat transfer block. It is of course also possible to use microfluid elements of a different design, which are not necessarily produced in the form of a chip, with the shape of the connection block or heat transfer block in each case being matched to the microfluid element.

The individual connections in the connection block are connected to the connections arranged in the housing via hoses and lines. If the microfluid element should malfunction, it can be removed and replaced without further effort, in particular without manual detachment and reconnection of connections and connecting lines. In addition, various connection blocks or heat transfer blocks can be used whose shape and connection arrangement are matched to various geometries of microfluid elements.

According to an embodiment of the inventive idea, it is provided that the connection block has devices for temperature control. Possible here are, for example, electric heating, in particular resistance heating, or a fluid-driven heat exchanger with a pre-definable fluid temperature, which is arranged in the heat transfer block and optionally in the connection block. Temperature control by one or more Peltier elements, by inductive or microwave-induced heating can likewise be used. It is also possible for various temperature control methods to be combined with one another or to be used simultaneously or at different times, depending on the reaction process currently being carried out.

It is preferably provided that the temperature of the microfluid element can be regulated. To this end, one or more sensors for temperature measurement are arranged in the immediate vicinity of the microfluid element. The connection block and the heat transfer block can have sufficiently small dimensions to cause only slight thermal inertia during temperature changes owing to the resultant low thermal capacity of the blocks. Rapid, effective temperature control within a broad temperature range is thus possible, enabling both the production of extremely small amounts of chemicals and also rapid parameter screening for experimental trials.

According to a further embodiment of the inventive idea, it is provided that sensors, such as, for example, pressure, flow, conductivity, temperature, optical or pH sensors, are arranged on the microfluid element in the housing. The individual sensors can be connected to external measuring instruments via corresponding connecting lines passed through the housing and provided there with detachable connections, and supply these measuring instruments with measurement values. Since the individual sensors are in each case located in the interior of the housing and can be activated when needed, undesired influencing of a reaction proceeding in the microfluid element is substantially excluded. The arrangement of the individual sensors, which does not have to be modified even on changing of a microfluid element, thus remains reproducible over a large number of experimental series and enables reliable and repeatable measurements.

It is likewise provided that microfluid components, such as, for example, valves, non-return valves or pumps, are arranged on the microfluid element and/or the microfluid channel connections. Microfluid components of this type facilitate controlled performance of the reaction and fluid flow control within the microprocess part or the microfluid element which is substantially independent of external fluid supply or subsequent process steps.

It is advantageously provided that a connecting element for connecting individual housings has a conical screw which presses a locking pin, which has a hole matched to the conical screw and projects out of the first of the housings to be connected, into a recess, matched to the locking pin, of a second housing matched to the locking pin in a detachably fixed manner. On connection of two housings, firstly the locking pin of the first housing is inserted into the recess matched thereto, usually a hole, of the second housing and connected in a fixed manner to the second housing by means of a conical screw which can be screwed to the second housing and whose conically tapering section projects through the hole of the locking pin. The arrangement of the hole in the locking pin and the design of the conical section of the conical screw are matched to one another in such a way that the locking pin and the first housing connected thereto are pressed against the second housing increasingly more firmly with increasing screwing of the conical screw into the second housing. In this way, a defined contact pressure of the two housings can be achieved using simple means, also ensuring reliable and tight connection of the associated fluid connections of the two housings.

According to an embodiment of the inventive idea, it is provided that the housing has, on the side faces, projecting shapes and recesses for a positive arrangement of individual housings relative to one another. In addition to the locking pin, projections and recesses matched thereto simplify accurate positioning of the housings to be connected relative to one another. It is thus ensured that, even in the case of a connection of two housings to be made rapidly, the associated fluid connections and optionally electric contacts are connected or made reliably and tightly. In addition, this type of connection ensures security against confusion of the side faces of two housings to be connected.

It is advantageously provided that the microprocess part has, on the bottom face of the housing, devices for the detachable attachment of the microprocess part to a base plate. Although the connection technology of the individual housings in many cases facilitates reliable connection of a plurality of housings to one another and thus the construction of a complex microreaction plant without further aids, it may be sensible for certain applications to attach the individual microprocess parts to a common base plate. The common base plate can on the one hand contribute to additional reliable connection of the individual microprocess parts to one another and on the other hand facilitates the attachment of further components, such as, for example, of external measuring instruments, which are used together with the microreaction system.

Further sub-claims relate to further embodiments of the inventive idea. An illustrative embodiment of the invention is explained in greater detail below with reference to the drawing, in which:

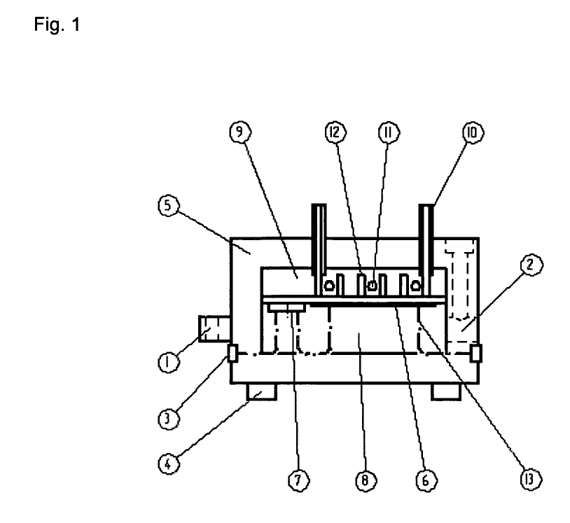

FIG. 1 shows the construction of a microprocess part in principle, where the individual components are depicted pulled apart for better clarity and

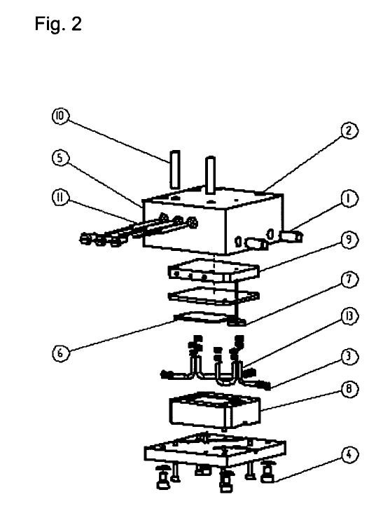

FIG. 2 shows the construction of a complex microprocess system comprising a plurality of microprocess parts as shown in FIG. 1 connected to one another.

FIG. 1 shows an illustrative embodiment of a microprocess part whose individual components are shown in pulled-apart view. During assembly of the individual components, the microprocess part is usually held with the underside facing upwards, as depicted in FIG. 1.

In the embodiment depicted, the microprocess part has a housing 1, which is made of polyaryl ether ketone (PEEK) owing to the desired thermal insulation properties. The housing 1 could also be made of any other suitable thermally insulating material, such as, for example, ceramic, or a plastic which meets the requirements. A heat transfer block 2 and a connection block 3, between which is located a microreaction chip 4, are arranged in the interior of the housing 1. The microreaction chip 4, as a specific example of any desired microfluid element, has fluid channels (not depicted), whose characteristic dimensions are in the micron range. The microreaction chip 4 is usually made from a thin glass plate or a silicon chip by means of known shaping or structure-forming processes. Furthermore, other types of microreaction chip 4 in which the microreaction chip 4 is made of metal or plastic are known and conceivable. Various embodiments of microreaction chips 4 or very generally microfluid elements which facilitate process operations, such as metering, temperature control, reactions, mixing, holding up, extraction, separation, evaporation or rectification, are known.

In order to ensure the fastest and most uniform temperature control possible of the microreaction chip 4, a material of high thermal conductivity, such as, for example, copper or aluminium, is usually used for the heat transfer block 2 and the connection block 3.

As a consequence of production, the heat transfer block 2 consists of a base block 5, which has meander-shaped grooves 6 for passing-through of a temperature-control medium. The meander-shaped grooves 6 are tightly covered by a sealing plate 7. The sealing plate 7 has, on the side facing the connection block 3, a recess 8 matched to the dimensions of the microreaction chip 4.

A plurality of microchannel fluid connections 9 are arranged in the connection block 3 in such a way that the usual, different microreaction chips 4 can in each case be brought into contact with fluid. Use is made here of commercially available connection systems which make a sufficiently tight fluid connection under appropriate contact pressure.

After the microreaction chip 4 has been placed in the recess 8, the connection block 3 and the heat transfer block 2 are screwed tightly to one another. Supply lines for the temperature-control medium 10 and heating cartridges 11 are connected to the heat transfer block 2 through holes, in each case matched thereto, from the outside through the housing 1. In this way, it is achieved that the temperature of the microfluid element can be controlled by means of a temperature-control device operated electrically or by means of a fluid heat transfer medium.

In the illustrative embodiment shown, the heat transfer block 2 has a further recess 12 for the accommodation of a sensor 13. The sensor 13, owing to its embedding in the heat transfer block 2, is brought to the same temperature as the microreaction chip 4, enabling substantially unfalsified measurements.

The microchannel fluid connections 9 are connected to fluid connections 15 arranged in the side walls of the housing 1 via piping 14, indicated only diagrammatically. Not depicted are further electric connections between the connection block 3 or the heat transfer block 2 and the outside of the housing 1, which can serve, for example, for energy transfer or control and evaluation of further measurement devices. For contacting of this electric connection (not depicted), additional connections, such as, for example, individual plug connections, multiple plug connections or terminal strips, may be provided on the outside of the housing 1.

Likewise not depicted is the possibility of arranging, on an outside of the housing, displays in the form of LEDs or LCD displays, which can indicate the conditions and properties measured in the interior of the housing without external measuring and display instruments being necessary.

The housing 1 has projecting guide pins 16 and holes 17 matched thereto. On connection of two housings 1, the guide pins 16 of a first housing 1 must be introduced into the holes 17 of a second housing 1, ensuring precise and reliable alignment of the individual housings 1 to one another.

A locking pin 18 which is firmly connected to the first housing 1 and has a hole 19 running transversely to its longitudinal axis is inserted into a hole 20, matched thereto, in the side wall of the second housing 1. A conical screw 21 having a threaded section 22 and a conically tapering section 23 is screwed to the second housing 1 in such a way that the conically tapering section 23 engages with the hole 19 of the locking pin 18 of the first housing 1 and presses the locking pin 18 and the first housing 1 connected thereto against the second housing 1 increasingly more firmly. The individual microprocess parts can accordingly be connected to one another or re-separated from one another in a simple manner by screwing-in or loosening the conical screw 21. The contact pressure necessary for a tight connection of the fluid connections 15 of two housings 1 associated with each can be ensured by corresponding screwing-in of the conical screw 21.

For protection against environmental influences, the housing 1 can be sealed by means of a base plate 24 which is screwed to the housing 1.

In the illustrative embodiment, shown in FIG. 2, of a complex microreaction system built from a plurality of microprocess parts, seven microprocess parts are each connected to one another. Further microprocess parts can be connected in a simple manner to the microreaction system shown via the guide pins 16 and the associated holes 17, where the locking pin 18 and the housing 1, connected thereto, of the microprocess part being newly added are connected firmly and the fluid connections 15 associated with each are connected tightly to one another by screwing in the conical screw 21.

The connection technology depicted facilitates the construction of complex microreaction systems merely by assembling the individual microprocess parts. It may be sensible for various applications to attach the individual microprocess parts to a common base plate. The individual housings 1 are then fixed via the respective base plates 24, which can be positioned in recesses, matched thereto, of the base plate and optionally additionally attached.

1. Microprocess part having at least one microfluid process element (4) and having microfluid channel connections (9), where the microprocess part is arranged in a thermally insulating housing (1), the microfluid channel connections (9) are passed through the housing (1), and connecting elements for connecting individual housings (1) are arranged on the housing (1) in such a way that the microfluid channel connections (9) associated with each can be tightly connected to one another.

2. Microprocess part according to claim 1, characterised in that the microfluid element (4) is surrounded essentially completely by thermally conducting material.

3. Microprocess part according to claim 1, characterised in that the thermally conducting material is aluminium or copper, and the housing (1) consists of thermally insulating material, in particular of plastic, such as, for example, polyaryl ether ketone (PEEK), or of ceramic.

4. Microprocess part according to claim 1, characterised in that the microfluid element (4) is arranged between a connection block (3) having microfluid channel connections (9) arranged in the connection block (3) and a heat transfer block (2) having devices for temperature control.

5. Microprocess part according to claim 4, characterised in that the connection block (3) has devices for temperature control.

6. Microprocess part according to claim 1, characterised in that the temperature of the microfluid element (4) can be controlled by means of a temperature-control device operated electrically and/or by means of a fluid heat transfer medium.

7. Microprocess part according to claim 1, characterised in that the temperature of the microfluid element (4) can be regulated.

8. Microprocess part according to claim 1, characterised in that sensors, such as, for example, pressure, flow, conductivity, pH or optical sensors, are arranged on the microfluid element (4) in the housing (1).

9. Microprocess part according to claim 1, characterised in that microfluid components, such as, for example, valves, non-return valves or pumps, are arranged on the microfluid element (4) and/or the microfluid channel connections (9).

10. Microprocess part according to claim 1, characterised in that a connecting element for connecting individual housings (1) has a conical screw (21) which presses a locking pin (18), which has a hole (19) matched to the conical screw (21) and projects out of the first of the housings (1) to be connected, into a recess (20), matched to the locking pin (18), of a second housing (1) in a detachably fixed manner.

11. Microprocess part according to claim 1, characterised in that the housing (1) has, on the side faces, projecting shapes and recesses for a positive arrangement of individual housings (1) relative to one another.

12. Microprocess part according to claim 11, characterised in that the housing (1) has projecting guide pins (16) and holes (17) matched thereto.

13. Microprocess part according to claim 1, characterised in that the microprocess part has, on the bottom face of the housing (1), devices for the detachable attachment of the microprocess part to a base plate.
